(19) United States
(12) Patent Application Publication
(10) Pub. No.: US 2004/0021535 A1
(43) Pub. Date: Feb. 5, 2004

(54) Automated dielectric resonator placement and attachment method and apparatus

(76) Inventors: Kenneth Buer, Gilbert, AZ (US); Ramanamurthy V. Darapu, Chandler, AZ (US); John Decamp, Mesa, AZ (US); Deborah Dendy, Tempe, AZ (US); Phillip Denisuk, Chandler, AZ (US); Noel Lopez, Phoenix, AZ (US); Edwin Stanfield, Queen Creek, AZ (US)

Correspondence Address: Patrick L. Mixon, One Arizona Center, 400 E. Van Buren, Phoenix, AZ, 85004-2202, US

(21) Appl. No.: 10/209,709

(22) Filed: Jul. 31, 2002

(51) Int. Cl. H01P 7/10

(52) U.S. Cl. 333/219.1

(57) ABSTRACT

A method for affixing a resonator to a printed circuit board is provided. The method uses a thin metal film which may be affixed to a surface of a stand off, or directly to a surface of a resonator. The metalized surface may be affixed to a printed circuit board using a molten agent with a surface tension which withstands the downward force exerted by the puck's weight. The metalized surface may be affixed to a printed circuit board using a solder paste and the solder is allowed to reflow. The surface tension of the molten solder causes the resonator (or resonator puck) to self-center, ensuring proper placement and eliminating the need for repositioning. Since the resonator is not positioned using traditional glues which are subject to shifting during transportation or curing, then the resonator is not subject to shifting, eliminating the need to reposition the resonator after the resonator becomes fixed.

### FIELD OF INVENTION

The invention relates to a method for the placement of a dielectric resonator on a printed circuit board.

### BACKGROUND OF THE INVENTION

Dielectric resonators are commonly used in filters, oscillators and other electronic devices. Although different forms of dielectric resonators are commercially available, the dielectric resonators that are most often used have the form of a short circular straight-wall cylinder which may have or may not have an axially-extending hole in the center of the cylinder and a length-to-radius ratio which is often close to one. In some instances, the resonators are often surrounded by a shielding casing to prevent radiation losses. The casing defines a microwave filter cavity.

Although not achievable in practice, the dielectric resonators should ideally hang freely in space. It is therefore necessary to mount the dielectric resonator firmly within a cavity with the aid of some form of mounting device. Conventionally, the mounting device may be a “stand off.” The stand off typically consists of a ceramic disc which is suitably fastened to the resonator. In combination, the dielectric resonator and the stand off may be termed the dielectric resonator puck (“DR puck”).

In practice, the DR puck couples to a transmission line and causes a sharp resonance in the frequency response of the circuit. The position of the DR puck with respect to the transmission line is critical and must be controlled to ensure proper circuit performance. The coupling of the DR puck to the transmission line must be controlled in the x, y, and z directions. Therefore, it is critical that the DR puck be centered properly and not allowed to move position.

FIG. 1 depicts a typical mounted DR puck in accordance with the prior art. FIG. 2 illustrates a prior art method which may be used to mount the DR puck. The method illustrated may be practiced using any conventional circuit board assembly apparatus machines or robots as may be found in the prior art. As shown in FIG. 1, the resonator 120 may be mounted to a stand off 122. The resonator 120 may be affixed to the stand off 122 prior to the resonator 120 and stand off 122 combination (hereinafter called “DR puck 120, 122”) being mounted onto the printed circuit board 126.

In a typical prior art mounting method shown in FIG. 2, the circuit substrate 126 may be screen printed with the intended circuit design (step 102). The screen-printing may indicate where on the printed circuit board 124 a specific component is to be affixed. That is, the circuit design may be imprinted on the substrate 126 to indicate the specific placement of the passive, active, or chip and/or other circuit components. A solder paste may be applied to the printed circuit board for holding the circuit components in place. The solder paste may be applied to the circuit board such that the applied solder paste traces (e.g., follows) the imprinted circuit design. The circuit components may then be placed on the printed circuit boarding the solder paste in accordance with the screen printing (step 104).

Once the circuit components are placed on the printed circuit board, the board may be heat treated to “reflow” the solder. Heat treating may be accomplished by passing the circuit board through a reflow oven at sufficient temperature to soften or melt the solder. Upon removing the printed board from the heat, the solder is permitted to harden, and the circuit components are held in place. In this context, “reflow” may mean the controlled process of melting a solderpaste, which consists of various soft, low melting point metals in ball or powder form mixed with a liquid or paste fluxing agent. The solderpaste may typically be melted in a high temperature environment, such as, for example, a heated plate or an oven that is heated by infrared or thermal heat sources containing hot air or hot gas that is recirculated. In some instances, the solderpaste may be heated in a vapor phase chamber that contains both the liquid and vapor phases of a boiling liquid. The resulting melted solder may then be returned to a lower temperature where it re-solidifies.

It should be noted that the prior art method for assembling circuit board components typically involves mounting the DR puck 120, 122 under a different process, and at a different time than is used with the circuit components. The process for mounting the DR puck 120, 122 typically involves identifying the location for mounting the DR puck 120, 122 and applying epoxy 128 to that location (step 108). The DR puck 120, 122 may then be placed on the epoxy 128 to be held into place (step 110). The epoxy may then be allowed to dry or may be cured to speed up the drying process (step 112). The finished circuit board device 100 may be subjected to various quality control test to ensure that the circuit is operating as designed (step 114).

In some instances, the position of the DR puck 120, 122 may shift during assembly of circuit board product, which may severely degrade DR 120 performance. For example, such shifting may be due to shifting of the DR puck 120 during assembly, during transportation of the board, and/or while the epoxy 128 is still uncured, or during the curing process, etc. To ensure proper placement of the components, the finished circuit board product is subject to quality control testing (step 114). Where the DR puck 102, 122 is found to be improperly positioned due to shifting or improper placement, the DR puck may be removed (step 116) and reset. That is, the epoxy may be re-dispensed (step 108) at the location where the DR puck 120, 126 is to be placed, and DR puck 120, 122 may be repositioned (step 110) and the epoxy re-cured (step 112).

As can be seen then, a more efficient method of placing the DR puck 120, 122 is needed. A preferable method may eliminate or substantially reduce the need to reposition the DR puck 120, 122 during circuit board product assembly. The preferred method may include less processing steps which would make the method more efficient than the prior art.

### SUMMARY OF THE INVENTION

The present invention addresses many of the shortcomings found in the prior art, especially in the area of automated resonator placement. In one aspect, the present invention takes advantage of cohesive properties (e.g., surface tension) of solder to ensure proper positioning of a metalized dielectric resonator puck and support. Once the metalized resonator puck and support are positioned on the printed circuit board, the printed circuit board is heated permitting the solder to “reflow,” and center the resonator puck automatically. That is, the surface tension of the solder causes the puck and support assembly to center itself over the solder application area on the printed circuit board. Since the metalized dielectric resonator puck and support assembly centers itself due to the solder surface tension, the puck is properly positioned. Thus, after being initially placed on the printed circuit board and subjected to solder reflow, the need to remove and reposition the dielectric resonator puck is eliminated. Consequently, in another aspect, the invention provides a method which is more efficient than the prior art, since processing steps are eliminated.

In one exemplary embodiment of the present invention, a dielectric resonator (DR) puck (e.g., stand off and resonator combination) is provided which includes a metallization film on one surface of the puck stand off to aid the puck in self-centering as the solder reflows. The resonator support surface opposite the puck would be coated with a metal film, such as for example, silver, nickel, tin lead, or the like. In particular, the surface of the puck opposite the affixed resonator is coated with a thick film metal which may be fired into place. The metalized puck may then be mounted onto a printed circuit board along with the other circuit components. In one exemplary embodiment the metalized puck may be placed on the printed circuit board using any standard component application process and or conventional manufacturing machine (e.g., robot).

In another exemplary embodiment, a dielectric resonator is disclosed which is metalized on one surface. That is, one surface of the resonator is coated with a thin metal film of solderable material. The metalized resonator may then be positioned on a circuit board by placing the metalized surface of the resonator in a solderpaste and subjecting the solder paste to a reflow process, during which the dielectric resonator is repositioned (e.g., self-centered).

In another exemplary embodiment, the present invention discloses a circuit board device including a metalized puck which has been affixed to a printed circuit board using solder. The circuit board device may include various electrical components which are soldered in place, and may be used in any circuit device requiring a resonator.

In yet another embodiment of the invention, a method for assembling a circuit board device with a metalized puck is disclosed. The method includes placing a solder paste onto a printed circuit board, aligning the metalized puck, and sending the printed circuit board containing the puck through an oven to reflow the solder.

### BRIEF DESCRIPTION OF THE DRAWINGS

The accompanying drawings, wherein like numerals depict like elements, illustrate exemplary embodiments of the present invention, and together with the description, serve to explain the principles of the invention. In the drawings:

FIG. 1 is an exemplary depiction of a prior art dielectric resonator puck affixed to a printed circuit board;

FIG. 2 is a flowchart of an exemplary prior art method for placement of circuit components onto a printed circuit board;

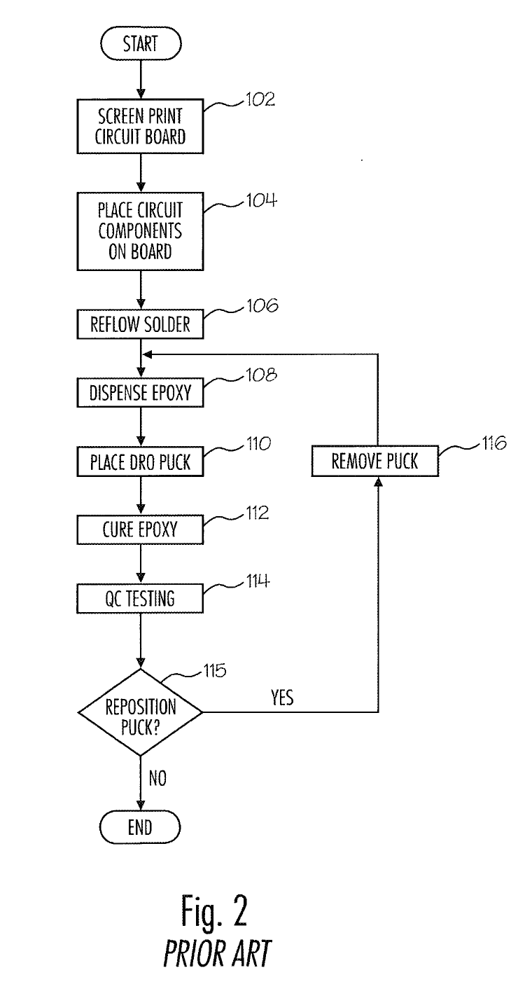

FIG. 3 is a depiction of a metalized stand off in accordance with the present invention;

FIG. 4 is an exemplary dielectric resonator puck in accordance with the present invention;

FIG. 5 is a portion of an exemplary printed circuit board in accordance with the present invention;

FIG. 6 is a depiction of a mounted dielectric resonator puck in accordance with the present invention; and

FIG. 7 is a flow chart of an exemplary method for mounting a dielectric puck in accordance with the present invention.

### DETAILED DESCRIPTION

The present invention provides a circuit board including a metalized dielectric resonator (“DR”) puck affixed to the circuit board using solder. The invention takes advantage of the cohesive property (e.g., surface tension) of the solder which permits the metalized DR puck assembly to self-center during solder reflow. By allowing the DR puck to self-center, the placement of the puck is precisely aligned to the initial placement of the solder. That is, once the solder is accurately placed, the metalized DR puck assembly may be positioned on the solder and the puck may center itself in relation to the solder's placement.

As used herein the term puck may refer to any combination of a resonator and a support (e.g., stand off) wherein the resonator is attached to one surface of the stand off. In general, the stand off may be any support permitting the resonator to be positioned above the planar surface of a printed circuit board. In one exemplary embodiment, the stand off may be ceramic, Cordierite (Mg, Al, Silicate), Forsterite (Mg, Silicate), Rexolite, or some other material suitable for supporting a dielectric resonator. The stand off may include a short circular straight-wall cylinder which may have or may not have an axially extending hole in the center of the cylinder and a length-to-radius ratio which is often close to one. The stand off may include a first flat surface parallel to a second flat surface, where the first and second flat surface may be on opposite ends of and perpendicular to the cylinder walls. The resonator may be affixed to the first flat surface using any conventional method for affixing. For example, the resonator may be affixed to the stand off using an epoxy. Such epoxies are known to those skilled in the art.

A typical resonator for use with the present invention may be coupled to other circuitry on the printed circuit board. In one exemplary embodiment, the resonator may be cylindrical and may be suitably shaped or configured to be affixed to the first flat surface of the stand off. As noted, the resonator may be affixed to the first flat surface using any epoxy suitable for such purposes.

In accordance with one exemplary embodiment, the second flat surface of the puck may be metalized in order to adhere to the solder during the reflow process. That is, the second flat surface may include a thin film coating of metal. In a preferred embodiment, the metal may be solderable. The metal may be affixed in any conventional method as may be suitable for the composition of the stand off. For example, where the stand off is ceramic, the thin metal layer may be fired into place. The metal film may consist of gold, silver, tin lead, nickel or any other solderable metal suitable for forming a thin metal film.

The metalized puck may be placed on a printed circuit board using any conventional device for placing circuit components on a circuit board. For example, a conventional manufacturing robot may be used to place the puck onto a printed circuit board surface. In one exemplary embodiment, the conventional device for placing circuit components may place the puck onto the circuit board in a similar manner as is typically done with electrical circuit components. The puck may be placed simultaneously with the other circuit components or may be placed in turn with the circuit components.

It should be noted that the present invention may be described with respect to a dielectric resonator and stand off. However, the invention is not so limited. For example, the present invention may be practiced including a dielectric resonator wherein one surface of the resonator is metalized with a thin metal film as described above with respect to the puck. That is, one surface of the dielectric resonator may be coated with a thin metal coating of solderable material, such as, for example, nickel, silver gold, lead, or tin. The coated surface may be placed in a solderpaste for soldering the dielectric resonator to, for example, a printed circuit board during a typical reflow process.

In accordance with another exemplary embodiment of the present invention, a printed circuit board is disclosed which includes metalized pucks affixed to the board using solder. Once placed, metalized pucks are heat treated along with other circuit components so that the solder may be permitted to reflow. The solder may then be permitted to cool, holding the circuit components and the puck into place.

In accordance with another exemplary embodiment of the invention a method for affixing the DR puck is disclosed. The method is more efficient than the prior art methods in that the method has a reduced number of steps required for affixing the DR puck to a printed circuit board. For example, the method according to the present invention excludes the steps of dispensing epoxy, independently placing the DR puck, and curing the epoxy. The method according to the present invention permits the metalized DR puck assembly (or metalized resonator) to be placed on a printed circuit board simultaneously with the placement of other electrical circuit components. In addition, the metalized DR puck assembly may be affixed to the printed circuit board using conventional solder. The solder may be placed on the circuit board in the location for eventual placement of the DR puck (herein called, “DR puck solder location”). The DR puck may then be placed on the DR puck solder location using any conventional machine or robot for placing circuit components on a circuit board. The exact placement of the DR puck on the printed circuit board is not critical in the present invention due to the self-centering of the DR puck on the metalized circuit board during the reflow process. This allows for standard pick and place machines to be used in the assembly, eliminating the requirement for highly accurate and costly placement procedures.

Once the DR puck is placed, the solder is subjected to heat to reflow the solder. The solder then is changed into a substantially liquid form wherein the surface tension of the solder floats the puck in the solder liquid form, and repositions the puck until it is centered in the DR puck solder location. Accordingly, the method according to the present invention eliminates the need to reposition the DR puck due to shifting of the puck caused by moving or jostling the board prior to the solder being permitted to harden. Thus, the method according to the present invention is more efficient and less expensive than conventional prior art DR puck application methods.

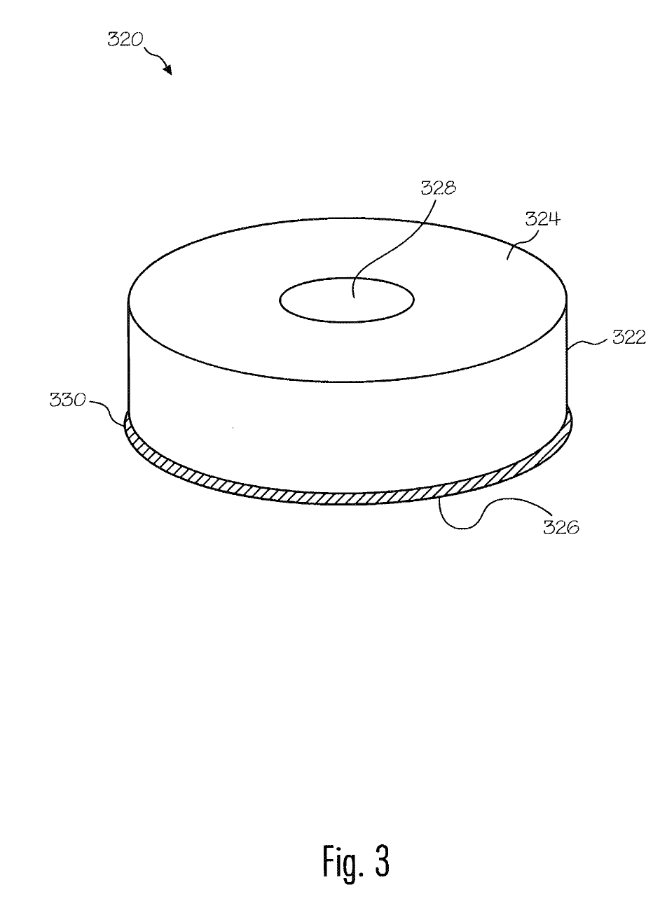

FIG. 3 illustrates an exemplary support 320 (e.g., stand off 320) in accordance with an exemplary embodiment of the invention. The stand off 320 may cylindrical and low profile in shape. Thus, the stand off 320 may include a straight circular side wall 322 and a first flat surface 324 situated perpendicular to the straight side wall 322. Stand off 320 may further include a second flat surface 326 parallel to the first flat surface 324 and perpendicular to the side wall 322. Positioned along the central axis of the stand off 320 from the first flat surface to the second flat surface may be a central bore 328, although the central bore is not mandatory.

In one exemplary embodiment, the second flat surface 326 of the stand off 320 may be coated with a thin metal film 330. In this context the coating of the stand off with the metal film may be called metalizing the stand off. The thin metal film may be composed of any metal suitably capable of being securely affixed to the second flat surface 326 and which may be suitable for bonding with solder. Typical examples of the metal which may be used includes gold, silver, tin lead, and nickel, although others are contemplated to be within the scope of the invention.

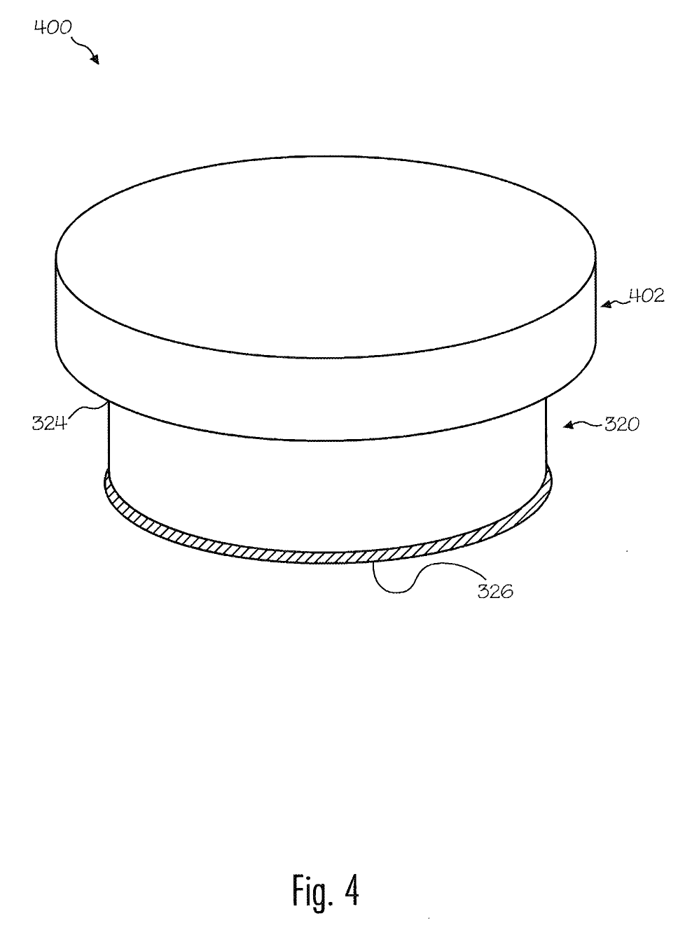

FIG. 4 illustrates an exemplary metalized DR puck 400 in accordance with the present invention. DR puck 400 includes the stand off 320 of FIG. 3. As can be seen, a dielectric resonator (DR) 402 is affixed on the first flat surface 324 of stand off 320. The DR 402 may be any DR puck that couples to microwave circuitry to provide a resonance in the response of microwave signals. For example, typical DRs which may be used cylinders of dielectric material for the purpose of creating a resonance at a desired frequency. Other shapes of dielectric material may also be used as resonators. The DR may be affixed to the first flat surface of using an adhesive, such as for example, an epoxy. As previously noted, stand off 320 includes a thin layer of metal on second flat surface 326. Thus, in combination, the resonator 402 and the stand off 320 comprise the metalized DR puck 400. Once the stand off 320 is metalized and the resonator 402 is affixed to the stand off 320 the DR puck 400 may then be prepared for use on a circuit board.

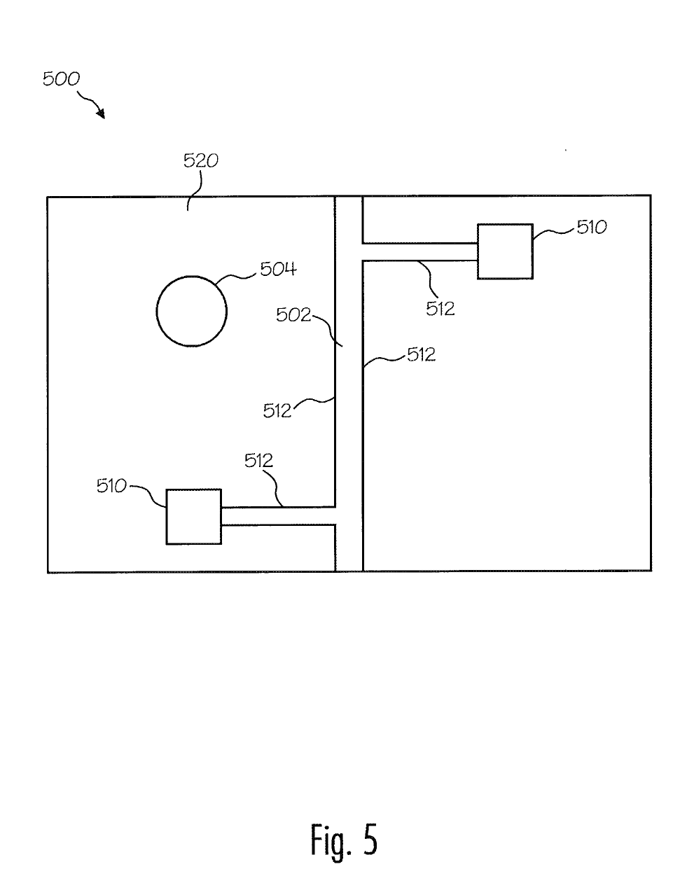

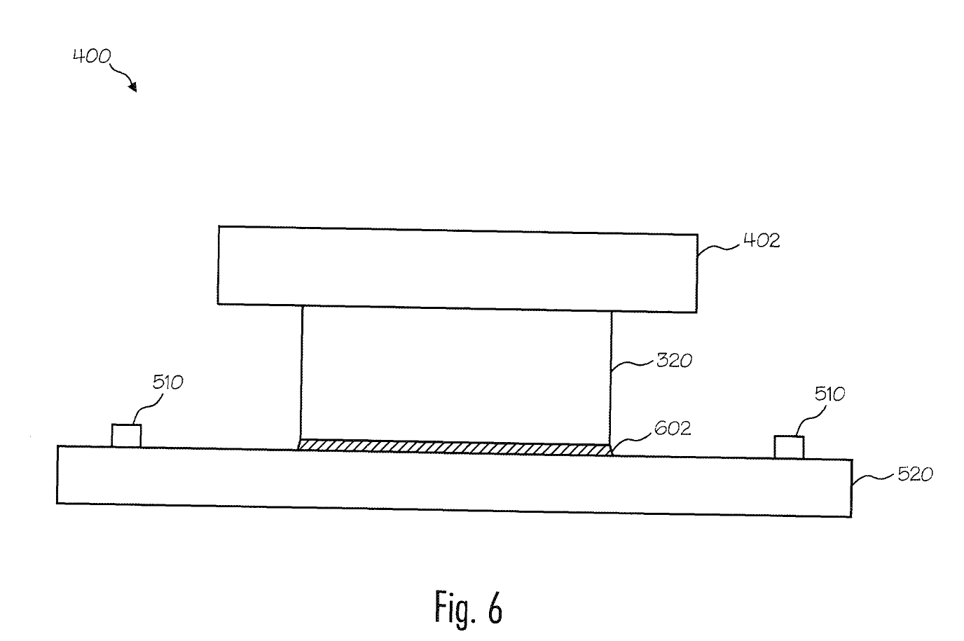

FIGS. 5-6 illustrates an exemplary circuit board including a DR puck 400 in accordance with the present invention. Particularly, FIG. 5 illustrates an exemplary circuit board 500 including a circuit board substrate 520. Circuit board substrate 520 may be screen-printed with a metalized circuit design 502 for identifying the locations at which the circuit components are to be affixed. For example, locations 510 may identify positions for affixing various circuit components, such as for example, lumped circuit elements, or microchips, etc. As will be discussed in detail below, situs 504 designates the DR puck solder location 504 where the DR puck 400 may be to be placed.

As can be seen the screen printing typically forms a particular circuit design 502 on the circuit board substrate 520 which comprises lines 512 connecting the locations 510 for affixing the circuit components. Typically, the circuit component locations 510 (and DR puck solder location 504) are overlaid with a solder paste (not shown). The solder paste may be any solder paste for use in affixing circuit components to a circuit board 520. The solder paste may be placed on the board 520 such that the solder paste follows (e.g., traces) the screen printed circuit design. Once the solder paste is applied, the circuit elements may be placed at their intended locations, in accordance with the circuit requirements.

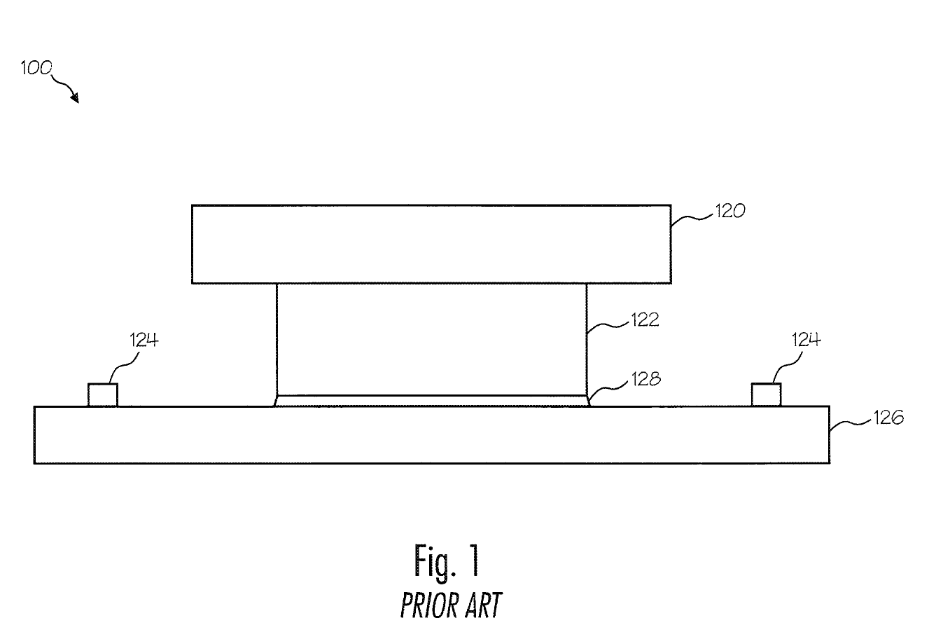

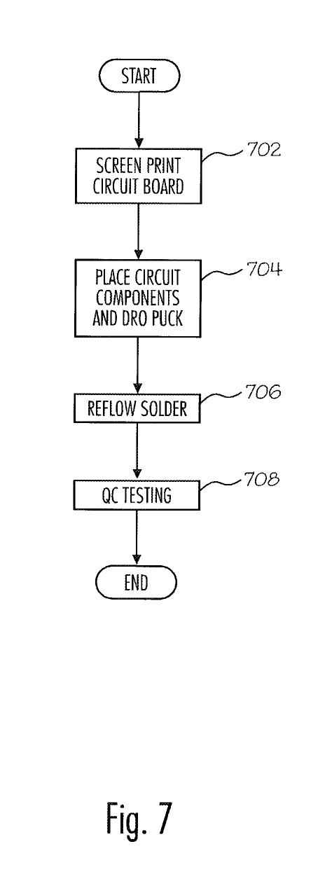

As previously noted with respect to FIG. 1, in the prior art a typical DR puck is attached to a printed circuit board using an epoxy. The DR puck may shift during transportation and/or during curing of the epoxy adhesive. Thus, prior art methods for affixing DR pucks to a printed circuit board are subject to imprecise placement of the DR puck which would later have to be removed and the placement process repeated or the assembly would require additional costly tuning methods. Thus, the prior art placement of the DR puck is inefficient in that it may lead to repetition in the puck placement or more costly tuning of the assembly. A more efficient method is illustrated in FIGS. 6 and 7, which show a DR puck placement method having fewer steps, and ensuring more efficient DR puck placement over the prior art.

FIG. 6 illustrates an exemplary printed circuit board 600 including metalized DR puck 400 affixed to its surface, in accordance with exemplary embodiments of the present invention. With brief reference to FIG. 5, DR puck solder location 504 identifies the location at which a DR puck 400 may be placed. The DR puck solder location 504 may be prepared by injecting or placing a solder paste centered at the DR puck solder location 504. Returning now to FIG. 6, DR puck 400 is shown placed at DR puck solder location 504. DR puck 400 is held in place by solder 602 centered at the DR puck solder location 504. As previously noted, the solder is placed as a solder paste (not shown) upon which the DR puck 400 is positioned using any conventional machine or method of placing circuit components on a printed circuit board (e.g., manufacturing robot).

An exemplary method in accordance with the present invention by which the DR puck 400 is secured to a printed circuit board at puck solder location 504 is illustrated in FIG. 7. As shown, the exemplary method may begin with the circuit board substrate 520 being screen printed (step 702) with the layout of the desired circuit. A solder paste may be placed on the circuit board substrate 520 in such a way that it follows (e.g., traces) the screen printed circuit. The circuit components along with the DR puck may then be placed in the solder at predetermined locations (step 704). The circuit components and the DR puck may be placed using any conventional machinery as is found in the prior art. As such, the machinery will not be discussed herein, for brevity.

As previously noted, the DR puck 400 is metalized on the surface of the puck which is positioned against the solder paste. Once the DR puck 400 is so positioned, the printed circuit substrate 520, including the components positioned in the solder paste, may be heat-treated to cause the solder paste to reflow (step 706). In one exemplary method, the printed circuit substrate 520 and components are placed in a reflow oven at a temperature sufficient for causing the solder paste to melt into a solder liquid which will later harden and fix the components in place. The temperature of the oven may be determined by the type and composition of the solder. Reflow temperatures for a particular solder are well known in the art and as such will not be discussed herein. In another exemplary embodiment, the solder may be subjected to infrared or vapor phase reflow, or the like, for ensuring converting the solder into a molten form which hardens and fixes the circuit components into place.

It should be noted that once the solder is converted to a liquid or molten form, the liquid solder may lift and center the DR puck 400 due to the cohesive nature of the solder molecules at the surface of the solder liquid. As is well known, the cohesive nature of the molten solder molecules at the surface causes the surface molecules to cohere to each other. Unless the cohesive forces are broken, the solder molecules will stick together and support (e.g., float, lift, etc.) any object which does not provide sufficient force for interrupting the molecular cohesiveness. Thus, the intermolecular surface forces (e.g., surface tension) which cause the surface molecules to cohere will also cause objects which are not weighted enough to break the intermolecular forces to float on the solder surface. Consequently, since the weight of the DR puck 400 is not enough to interrupt or break the cohesive forces of the at the surface of the molten solder, the DR puck 400 will float on the solder's surface and the DR puck 400 will self-center at the solder location 504. In this way, the puck 400 may be positioned as desired, and will not require replacement once the solder is permitted to harden. Once the solder hardens, the circuit components will be fixed into place. The printed circuit board with the fixed components may then be subjected to quality control testing to ensure that the circuit operates as desired (step 708).

The present invention has been described above with reference to various exemplary embodiments. However, those skilled in the art will recognize that changes and modifications may be made to the exemplary embodiments without departing from the scope of the present invention. For example, the various operational steps, as well as the components for carrying out the operational steps, may be implemented in alternate ways depending upon the particular application or in consideration of any number of cost functions associated with the operation of the system, e.g., various of the steps may be deleted, modified, or combined with other steps. Alternatively, additional steps (e.g. solder paste placement step may be added to illustrate alternate embodiments of the invention. In addition, the various circuit component placement systems disclosed herein may be modified or changed to accommodate additional pucks or circuit components as may be desired. The changes and/or modifications described above are intended to be included within the scope of the present disclosure, as set forth in the following claims.

1. A resonator puck comprising:
a resonator; and
a stand off including a first surface and a second surface, wherein at least a portion of said second surface is metalized with a thin metal film, said resonator attached to said first surface.

2. A resonator puck according to claim 1, wherein said metallic film is solderable.

3. A resonator puck according to claim 1, wherein said thin metal film comprises at lease one of nickel, silver, gold, lead, and tin.

4. A resonator puck according to claim 1, wherein said metalized second surface is configured to be in communication with a printed circuit board using a solder.

5. A resonator puck according to claim 1, wherein said stand off is ceramic.

6. A resonator puck according to claim 1, wherein said resonator is a dielectric resonator.

7. A resonator comprising first surface, the first surface including a solderable thin metallic film.

8. A resonator according to claim 7, wherein said solderable thin metallic film is comprised of at least one of nickel, silver, gold, lead and tin.

9. A circuit comprising:
a. a printed circuit board;
b. a resonator attached to said printed circuit board, the resonator including a first surface, said first surface metalized with a thin metal film.

10. A circuit according to claim 9, wherein said thin metal film is solderable.

11. A circuit according to claim 9, wherein said thin metal film is at least one of nickel, silver, gold, lead and tin.

12. A circuit comprising:
a. a printed circuit board; and
b. a resonator puck in communication with printed circuit board, said resonator puck including a metalized stand off and a resonator.

13. A circuit according to claim 12, wherein said resonator is affixed to said printed circuit board using a solder.

14. A circuit according to claim 12, wherein said stand off includes a first surface and second surface, said resonator affixed to said first surface, said second surface metalized with a thin metal film.

15. A circuit according to claim 12, wherein said stand off is ceramic.

16. A circuit according to claim 14, wherein said thin metal film is solderable.

17. A circuit according to claim 14, wherein said thin metal film comprised of at least one of silver, gold, nickel, tin, and lead.

18. A circuit according to claim 14, wherein said metalized second surface is coupled to said solder and said solder is in communication with said printed circuit board.

19. A circuit according to claim 1, wherein said resonator is dielectric.

20. A method for providing a circuit comprising:
providing a resonator puck including a resonator affixed to a first surface of a stand off, the stand off including a metalized second surface.

21. A method according to claim 20, further including the step of:
providing a printed circuit board coupled to the metalized second surface, the metalized second surface affixed to the printed circuit board using a solder, the first surface of the stand off in communication with the resonator.

22. A method according to claim 21, further including the step of affixing the stand off to the printed circuit board using a molten adhesive, the adhesive having a surface tension with a molecular cohesive force greater than a downward force exerted by the resonator puck.

23. A method according to claim 21, further including the step of affixing the stand off to the printed circuit board using one of a solder and solder paste.

24. A method according to claim 23, wherein said solder and solder paste is reflowed and permitted to harden, affixing the resonator to the printed circuit board.

25. A method for providing a circuit comprising:
providing a resonator puck including a resonator affixed to a first surface of a stand off, the stand off including a metalized second surface;
providing a printed circuit board in communication with the metalized second surface, the metalized second surface affixed to the printed circuit board using a solder, the solder composed to self-center the positioning of the resonator puck, the first surface of the stand off in communication with the resonator;
reflowing the solder; and
permitting the solder to harden, holding the resonator puck in place on the printed circuit board.

26. A method of providing a resonator including coating the resonator with a solderable thin metallic film.
